(19) United States
(12) Patent Application Publication
(10) Pub. No.: US 2024/0201672 A1
(43) Pub. Date: Jun. 20, 2024

(54) APPARATUSES, COMPUTER-IMPLEMENTED METHODS, AND COMPUTER PROGRAM PRODUCTS FOR IMPLEMENTING AUTOMATICALLY SELECTED REPORTING PROTOCOLS

(71) Applicant: Honeywell International Inc., Charlotte, NC (US)

(72) Inventors: Shahrul Azman Bin ZAINAL ABIDIN, Kuala Lumpur (MY); Madhukar Madhavamurthy GUNDAPPA, Bangalore (IN); Ramesh Murugan NATARAJAN, Bangalore (IN)

(21) Appl. No.: 18/184,975

(22) Filed: Mar. 16, 2023

(30) Foreign Application Priority Data
Dec. 20, 2022 (IN) 202211073870

(51) Int. Cl. G05B 19/418

(52) U.S. Cl. CPC G05B 19/41875; G05B 2219/34427

(57) ABSTRACT

Embodiments of the present disclosure provide for implementing at least one automatically selected reporting protocol. Some embodiments select a particular reporting protocol for use based at least in part on particular location data, for example location data associated with a processing plant, processing unit, and/or multiple processing plants individually. Some embodiments select a particular reporting protocol using a specially configured artificial intelligence model that learns a most probably accurate reporting protocol corresponding to particular location data. Additionally, some embodiments generate an operational report based at least in part on a selected reporting protocol and operations data received for a particular processing plant.

### CROSS-REFERENCE TO RELATED APPLICATIONS

This application claims priority to and the benefit of foreign Indian Provisional Patent Application Serial No. 202211073870, filed on Dec. 20, 2022 with the Government of India Patent Office and entitled “APPARATUSES, COMPUTER-IMPLEMENTED METHODS, AND COMPUTER PROGRAM PRODUCTS FOR IMPLEMENTING AUTOMATICALLY SELECTED REPORTING PROTOCOLS,” the contents of each of which are incorporated herein by reference in their entireties

### TECHNICAL FIELD

Embodiments of the present disclosure are generally include improved methodologies for automatically selecting and implementing a reporting protocol, and specifically to improved, automatic selection of a particular reporting protocol corresponding to a particular location and that is implementable to generate an operational report in accordance with the selected reporting protocol.

### BACKGROUND

Monitoring operations of an oil refinery or similar chemical plant is often important to understand various aspects associated with operation of the plant. In several contexts, for example, one or more entities may desire to monitor operations of a plant to determine how the plant is performing, the effects of the operations of the processing plant (e.g., environmental impacts), and/or other aspects of the plant. Different entities may desire to view, analyze, and/or interact with different data portions, data-derived values, and/or impacts from the operation of the plant. Similarly, different entities may desire to view, analyze, and/or interact with the same data portions, data-derived values, and/or impacts provided in different representations (e.g., different units of measurement) to easily enable interacting with such data. Different reporting protocols may be utilized to capture such differences between entities and otherwise.

Inventors have discovered problems with current implementations of implementing data processing and reporting, for example based on reporting protocol(s). Through applied effort, ingenuity, and innovation, the inventors have solved many of these problems by developing the solutions embodied in the present disclosure, the details of which are described further herein.

### BRIEF SUMMARY

In one aspect, a computer-implemented method for implementing at least one automatically selected reporting protocol includes receiving operations data representing operations of a processing plant, receiving location data, applying at least the location data to a protocol selection model, where the protocol selection model includes an artificial intelligence model that selects a reporting protocol based at least in part on the location data, and generating an operational report based at least in part on the reporting protocol and the operations data.

The computer-implemented method may also include where the operations data corresponds to a reporting level, the reporting level selected from at least one of a unit level, a site level, and an enterprise level.

The computer-implemented method may also include where the protocol selection model is further configured to select the reporting protocol based at least in part on industry type data.

The computer-implemented method may also include the computer-implemented method further includes generating a user interface alert that indicates at least one regulator required reporting protocol and at least the reporting protocol selected by the protocol selection model.

The computer-implemented method may also include where the protocol selection model receives an indication of internal reporting or external reporting, and where the protocol selection model is configured to select the reporting protocol based at least in part on the indication of internal or external reporting.

The computer-implemented method may also include where the protocol selection model includes a lookup table that indicates at least one candidate protocol for selection based on the location data, where the reporting protocol is selected from the at least one candidate protocol.

The computer-implemented method may also include where the protocol selection model generates a ranking for each of at least one candidate protocol, the computer-implemented method further includes causing rendering of a user interface includes the ranking for each of the at least one candidate protocol.

The computer-implemented method may also include where the artificial intelligence model is configured to predict a probability of each candidate protocol of a plurality of candidate protocols based at least in part on a plurality of historically selected reporting protocol.

The computer-implemented method may also include where the location data is received from a location sensor of a processing unit of the processing plant.

The computer-implemented method may also include where the operational report corresponds to a unit level and the location data represents a location of a processing unit of the processing plant.

The computer-implemented method may also include where the operational report corresponds to a site level and the location data represents the location of the processing plant.

The computer-implemented method may also include further includes receiving user input initiating the generation of the operational report, where the operational report is generated in response to receiving the user input.

The computer-implemented method may also include where the generation of the operational report is automatically initiated.

In another aspect of the disclosure, an apparatus for implementing at least one automatically selected reporting protocol is provided. An example apparatus includes at least one processor and at least one memory that, in execution with the at least one processor, causes the apparatus to perform any one of the example computer-implemented methods described herein. Another example apparatus includes means for performing each step of any one of the example computer-implemented methods described herein.

In another aspect of the disclosure, a computer program product for implementing at least one automatically selected reporting protocol is provided. An example computer program product includes at least one non-transitory computer-readable storage medium having computer program code stored thereon that, in execution with at least one processor, configures the computer program product for performing any one of the example computer-implemented methods described herein.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system diagram within which embodiments of the present disclosure may operate.

FIG. 2 illustrates a block diagram of an example apparatus in accordance with at least some embodiments of the present disclosure.

FIG. 3 illustrates an example communication system within which embodiments of the present disclosure may operate.

FIG. 4 illustrates example communication of location data in accordance with at least some embodiments of the present disclosure.

FIG. 5 illustrates an example visualization of computer-implemented operations selecting a reporting protocol using a protocol selection model in accordance with at least some embodiments of the present disclosure.

FIG. 6 illustrates an example user interface in accordance with at least some embodiments of the present disclosure.

FIG. 7 illustrates a process 700 for implementing at least one automatically selected reporting protocol in accordance with at least some embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

### Definitions

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

“Candidate protocol” refers to electronically managed data representing a particular reporting protocol that is selectable for use in generating an operational report corresponding to operation of a particular processing unit or processing plant.

“Enterprise level” refers to processing of data for multiple processing units and/or processing plants associated with a particular entity, such that the data associated with the multiple processing units and/or processing plants are processed together.

“External reporting” refers to electronically managed data indicating that an operational report is intended to be generated for a user or audience that is external, in whole or in part, from an entity that owns, controls, or otherwise operates a particular processing unit or a particular processing plant. In one example context, an external reporting corresponds to generation of an operational report to be transmitted or otherwise provided to a regulator or other entity external from an entity that controls, owns, or otherwise operates a particular processing plant.

“Historically selected reporting protocol” refers to electronically managed data representing a particular reporting protocol previously selected for generating an operational report associated with a processing unit or a particular processing plant. In some embodiments, data embodying a historically selected reporting protocol is associated with particular data representing characteristics of a corresponding processing unit or processing plant, operations performed by the processing unit or processing plant, and/or operations data associated with the processing unit or processing plant.

“Industry type data” refers to electronically managed data classifying a particular operation or multiple operations performed by a particular processing plant, or a particular processing unit of a processing plant, into one of a plurality of candidate industry types and/or processing types.

“Internal reporting” refers to electronically managed data indicating that an operational report is intended to be generated for a user or set of users that are a part of an entity that owns, controls, or otherwise operates a particular processing unit or a particular processing plant. In one example context, an internal reporting corresponds to generation of an operational report to be transmitted or otherwise provided to managers, agents, employees, or operators of a particular processing plant.

“Location data” refers to electronically managed data representing a particular absolute location or a relative location defined within a particular coordinate system. Location data may be associated with a particular processing unit of a processing plant, associated with the particular processing plant itself, and/or associated with an enterprise associated with one or more processing plants. Non-limiting examples of location data includes GPS data, latitude and longitude coordinate data, address data, country code data, and/or a custom identifier representing a particular jurisdiction within which a processing unit, processing plant, or enterprise is located.

“Lookup table” refers to at least one data structure that links a particular key data value, or combination of data values embodying a key data value, with any number of other data values including at least one candidate reporting protocol.

“Operational report” refers to electronically managed data that represents electronically managed data including a structured representation of particular operations data and/or data derived from one or more portion(s) of operations data. Each operational report is associated with a particular reporting protocol that defines the particular data to be included in the operational report, how to represent particular operations data or data derived therefrom within the particular operational report, methodologies for deriving data to be included in the particular operational report from operations data, where to transmit the particular operational report, and/or a schema for how often to generate the particular operational report.

“Operations data” refers to electronically managed data representing operations of a particular processing unit of a particular processing plant, operations of a combination of processing units of a particular processing plant, and/or operations of a combination of processing units of a plurality of processing plants.

“Processing plant” refers to an industrial plant that transforms one or more input ingredient(s) into a desired final product by performing at least one transformation via any number of processing units within the processing plant.

“Processing unit” refers to a machine, robot, system, and/or device embodied in hardware, software, firmware, and/or any combination thereof, that manipulates, routes, or otherwise processes one or more input ingredient(s).

“Protocol selection model” refers to at least one algorithmic, statistical, machine-learning, and/or artificial intelligence model that is configured to select a particular protocol selection model from a set of candidate protocols.

“Ranking” refers to electronically managed data representing a position of a data object hierarchy of data objects based at least in part on a particular metric. A ranking of a reporting protocol with respect to a determined probability of being appropriate for use in a particular jurisdiction represents a position of the particular reporting protocol in a hierarchical arrangement of candidate protocols based on the probability of the particular reporting protocol being appropriate for use as compared to other candidate protocols.

“Regulator” refers to an entity associated with a particular jurisdiction that imposes, enforces, and/or otherwise regulates particular rules regarding operation of a processing plant. A regulator requires submission an operational report corresponding to operations of a particular processing plant.

“Reporting level” refers to electronically managed data representing a manner in which operations data is to be grouped for processing, where one or more portions of operations data associated with one or more processing unit(s) are groupable based on a particular reporting level. Non-limiting examples of a reporting level include a unit level, a site level, and an enterprise level.

“Reporting protocol” refers to electronically managed data defining a manner in which particular data is to be processed, generated, and/or provided within a particular operational report corresponding to the reporting protocol.

“Set” refers to electronically managed data embodying one or more data structures that store zero or more instances of one or more data object type(s). A set of candidate protocols, for example, includes one or more data structure(s) that store data representing or corresponding to zero or more candidate protocols. Non-limiting examples of an implementation of a set include a set data structure, an array data object, a dictionary, a linked list, a plurality of interconnected but discrete data objects, and a custom data object.

“Site level” refers to processing of data for a particular processing plant, such that the data associated with multiple processing units of the particular processing plant are processed together.

“Unit level” refers to processing of data for a particular processing unit, such that the data associated with the particular processing unit is processed separately from data associated with other processing units.

“User input” refers to any electronically managed data representing an engagement, action, or other interaction with at least one computing device performed by a particular user that results in the particular data. Non-limiting examples of user input includes a click, a tap, a key press, a gesture, a voice command, a peripheral input, a mouse movement, and device motion.

“User interface” refers to any textual, image, or other visual representation of data that is renderable to a display or other output device for viewing and/or interacting with by a particular user.

“User interface alert” refers to a particular user interface, or sub-interface of a user interface, that includes data derived, determined, or otherwise identified associated with operation of a processing plant.

### Overview

In various contexts, users desire to monitor, track, and/or otherwise access information regarding operations of a particular plant. In several of such contexts however, for example oil refineries, petrochemical plants, and/or the like, much of the desired information is conventionally limited in availability. For example, often in such contexts, detailed emissions data is available only at particular points of annual reporting to regulatory bodies, internal auditing entities, internal management teams, and/or the like. Some entities, for example operational plant managers and/or the like, may desire to access such information with increased regularity, for example daily, week-to-week, monthly, and/or the like. In some contexts, plant managers, enterprise executives, or other users may desire to receive such monitored information in real-time based on current operation of one or more plant(s).

The information regarding operations of a particular plant may provide insight into various operational aspects of that particular plant, and/or effects thereof. For example, in some contexts, multiple users may seek to access emissions data associated with operations of a particular plant, or multiple plants. The emissions data may correspond to an amount of emissions that produce harmful effects to the environment have been and/or are being produced by the operations of the plant(s). Each of multiple entities may seek to access such emissions data for the same reason or for different reasons.

Regardless of the reasons a user seeks to access particular information regarding the operations of one or more plant(s), the desired representation of such information across the multiple users nevertheless may differ. For example, often a user may be unaware or otherwise unable to determine a reporting protocol that should be used to generate a corresponding operations report, for example including emissions data corresponding to one or more plant(s). In this regard, the reporting protocol may define a manner in which particular data is to be represented in a generated report, for example embodied by resulting data pushed to a user interface, a report file printable or downloadable from a system, and/or the like. In one such example context, a user may opt or desire to use particular reporting protocol(s) to generate a report of operations data associated with a particular plant to an internal management team for review, but may not be permitted to utilize the same reporting protocol to generate a report for providing to a regulatory agency where the plant is operating. Further still, in circumstances where an enterprise is associated with plants in various locations within differing jurisdictions, use of a particular reporting protocol to generate reports may be permitted only in one or some of such jurisdictions, and not permitted in others. Existing attempts to maintain reporting protocol selections often require manual selection and/or tracking, leading to introduction of user-caused errors in reporting protocol selection and use. Avoiding and/or rectifying such errors is particularly cumbersome, or in some contexts is impossible.

Improper use of a reporting protocol may result in any of a myriad of negative impacts. In some contexts, use of improper reporting protocols results in improper decision-makers, such as regulatory agencies and/or enterprise management teams, that result in an increased amount of emissions or other negative impacts to the environment. For example, improper reporting protocol usage may result in generation of a report that indicates or is interpreted to indicate that particular emissions minimization requirements are being satisfied and that emissions may be able to be increased in exchange for increased profitability, when in reality such emissions requirements are not being satisfied. Additionally, in some contexts use of improper reporting protocols results in fines across various jurisdictions, making such errors a costly factor. Additionally still, in some contexts use of improper reporting protocols impacts the reputation of an enterprise over time. It is desirable to minimize any and all such negative impacts.

Embodiments of the present disclosure automatically select at least one reporting protocol and/or automatically implement such an automatically selected reporting protocol. Embodiments of the present disclosure utilize a protocol selection model including or embodying an artificial intelligence (AI) model specially configured to automatically select a reporting protocol from a plurality of candidate reporting protocols for use in generating a report associated with operations of a particular plant, plurality of plants, or processing unit of a plant. In some embodiments, the protocol selection model is configured to select a reporting protocol from a plurality of candidate reporting protocols based at least in part on location data. In some embodiments, the location data is determinable based at least in part on sensor data (e.g., GPS data, and/or the like) from one or more sensor associated with a plant or processing unit thereof, or in other embodiments is retrievable or otherwise determinable from a data repository associated with a processing unit and/or plant. The location data in some embodiments is based at least in part on a reporting level, for example where the location data represents a location of a processing unit in a circumstance where a reporting level is chosen for a particular processing unit, where the location data represents a location of a particular plant in a circumstance where a reporting level is chosen for a particular plant, or where the location data represents a particular headquarters or centralized location in a circumstance where a reporting level is chosen for a plurality of plants in different jurisdictions.

Additionally or alternatively, in some embodiments, the protocol selection model is specially configured to select a reporting protocol from a plurality of candidate reporting protocols based at least in part on industry and/or process type data. In some embodiments, the industry and/or process type data indicates a type of input ingredients processed by the plant, a type of final product generated by the plant, and/or the like. Some embodiments identify or otherwise receive the industry and/or process type data based at least in part on a current configuration of one or more processing unit(s) of the plant, predetermined or stored data associated with operation of a plant, and/or the like.

Additionally or alternatively, in some embodiments, the protocol selection model is specially configured to select a reporting protocol from a plurality of candidate reporting protocols based at least in part on data indicating an entity to receive a generated report. In some embodiments, the data indicating the entity to receive the generated report indicates at least whether the report is intended for an internal user associated with an entity (e.g., a management user or operator) or an external user associated with an entity (e.g., a regulatory agency). Some embodiments receive the data indicating the entity to receive the generated report is received in response to user input.

In some embodiments, the protocol selection model includes an artificial intelligence model specially configured to process the one or more portion(s) of input data and select a reporting protocol that is predicted to be accurate for use from a plurality of candidate reporting protocols based at least in part on the input data. Additionally or alternatively, in some embodiments the protocol selection model, via the artificial intelligence model or one or more preprocessing models embodied as an algorithmic, statistical, and/or machine learning model, utilizes the location data to determine a subset of the plurality of candidate reporting protocols corresponding to a location represented by the location data. For example, some embodiments filter the plurality of candidate reporting protocols into a particular subset by identifying reporting protocols that are indicated in a knowledge base as acceptable for use associated with a particular location represented by the location data. In some such embodiments, the protocol selection model includes a lookup table that links at least one candidate reporting protocol to a particular location corresponding to particular location data. Additionally or alternatively, some embodiments filter the plurality of candidate reporting protocols based at least in part on the data indicating entity to receive the generated report, for example by identifying protocols indicated in a knowledge base as acceptable for use associated with a particular entity. In some embodiments, the artificial intelligence model subsequently selects a reporting protocol that is predicted to be accurate for use based on the input data from the remaining subset of candidate reporting protocols.

The selected reporting protocol is usable in any of a myriad of manners. Some embodiments generate an alert indicating at least one recommended reporting protocol selected by the protocol selection model. In some such embodiments, the alert may indicate a recommendation that is rendered to a user interface indicating that a user associated with the user interface is recommended to utilize the reporting protocol to generate a corresponding operational report. Some embodiments rank the plurality of candidate reporting protocols, or a subset thereof, and provides the rankings of the reporting protocols to a user for review. In some embodiments, one or more reporting protocols are arranged based at least in part on the rankings, for example such that the first ranked reporting protocol is provided first in the arrangement, second ranked reporting protocol is provided second in the arrangement, and so on. In some such embodiments, the user then interacts with or otherwise engaging with the arrangement of reporting protocols to select a particular reporting protocol for subsequent use.

Some embodiments additionally utilize an identified reporting protocol to generate a particular operational report. For example, some embodiments receive operations data representing operations of a particular plant, for example a processing plant. Additionally or alternatively, in some embodiments the operations data represents operations of a particular processing unit within a plant. In this regard, the operations data for a particular plant may be determined from the combination of operations data associated with each processing unit in the plant. In some embodiments, the operations data is received from sensors positioned in or otherwise associated with individual processing units of the plant, and/or otherwise disposed for monitoring one or more aspects of the plant. Additionally or alternatively, in some embodiments, the operations data is derived from another portion of data, and/or derived from a combination of different portions of operations data.

Some embodiments generate an operational report based at least in part on the selected reporting protocol and the operations data. For example, in some embodiments, the selected reporting protocol includes one or more data property factors utilized to derive data values for particular data properties of the operational report, for example emissions factors. Some such embodiments combine the factor(s) in the selected reporting protocol with one or more corresponding portions of the operations data to generate data value(s) for one or more data properties that are then included in the generated operational report. The operational report may be outputted to another system or subsystem for further processing, stored in a local data repository, rendered to a display associated with the embodiment, and/or transmitted to another system or device for storing, processing, and/or displaying. In some embodiments, the operational report is generated automatically upon selection. In other embodiments, the operational report is generated in response to user input requesting generation of the operations report.

Some embodiments provide one or more user interface(s), dashboard(s), and/or the like. In some embodiments, such user interface(s) provide generated operations report(s). The operations report in some embodiments provides particular data values for particular data properties (e.g., emissions data, usage data, key performance indicator(s), and/or the like) associated with operations of a particular processing unit, plant, and/or plurality of plants. For example, in some embodiments, a user may interact with the user interface to select a particular processing unit, plant, or plurality of plants for which to generate an operational report based at least in part on one or more selected reporting protocol. Additionally or alternatively, in some embodiments the user interface includes one or more additional sub-interface(s) and/or element(s) that depict a site map for a particular plant, a graphical view of emissions or other KPIs associated with plant operations, and/or the like. In some embodiments, the user interface is configurable to depict KPIs based on one or more filtered or configured processing units of a plant, for example by a particular source, a particular gas type, a particular type of processing unit, and/or the like. In this regard, the user interface may provide visualization of one or more data portion(s) received and/or derived based at least in part on a selected reporting protocol.

Embodiments of the present disclosure provide a myriad of technical improvements, resolve a myriad of technical problems, and provide a plurality of user-experience and business advantages. Embodiments improve the accuracy of the selected reporting protocol for use with respect to a particular processing unit, plant, and/or the like without biased or improper user influence. Such embodiments reduce and/or eliminate the effects of negative impacts associated with conventional improper reporting protocol selection, as described above.

### DETAILED DESCRIPTION

Embodiments of the present disclosure herein include systems, apparatuses, methods, and computer program products configured for and to perform one or more operations for implementing at least one automatically selected reporting protocol. It should be readily appreciated that the embodiments of the apparatus, systems, methods, and computer program product described herein may be configured in various additional and alternative manners in addition to those expressly described herein.

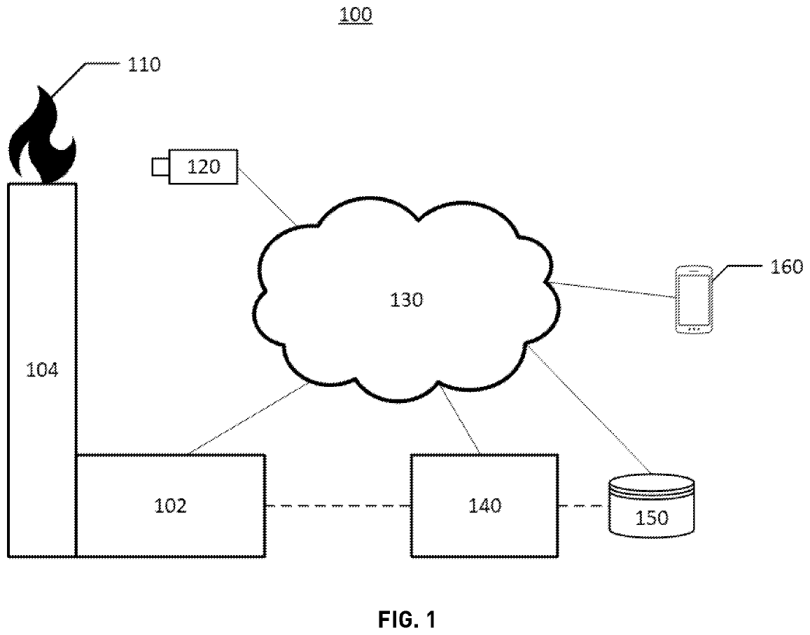

FIG. 1 illustrates an exemplary block diagram of an environment in which embodiments of the present disclosure may operate. Specifically, FIG. 1 illustrates a plant 102 that may be associated with a flare stack 104 (“stack 104”). In some embodiments, the plant 102 embodies a processing plant associated with a particular operational goal. For example, in some embodiments, the embodies a processing plant including any number of processing unit(s) that, alone or in combination, perform a particular industrial process. In some embodiments, the plant 102 includes or embodies an oil refinery, petrochemical plant, chemical processing plant, or other plant that converts one or more ingredient(s) into a final product by performing particular operations that utilize, process, manipulate, and/or otherwise transform the ingredient(s). It will be appreciated that the depicted and described plant 102 defines non-limiting examples of components and/or operation of particular processing plant(s), and should not limit the scope and spirit of the disclosure to merely these configuration(s). For example, in some embodiments, the plant 102 includes the stack 104, while in other embodiments the plant 102 may not include any such stack.

In some embodiments, the plant 102 includes the stack 104 as a particular processing unit thereof. The stack 104 may be used to flare and/or vent one or more gases. These gases may include, but are not limited to, greenhouse gases. Flaring of gases may generate a flame 110. The flame 110 of a stack 104 may be observed, measured, analyzed by, and/or the like by one or more sensors 120 in accordance with operations and/or functions described herein. A sensor 120 may generate and/or transmit sensor data across a network 130 to an operations processing system 140. The operations processing system 140 may be electronically and/or communicatively coupled to one or more plant(s), for example to plant 102, one or more databases 150, and one or more user devices 160. In some embodiments, the plant 102 embodies or includes a different type of processing plant, and/or does not include the flare stack 104. For example, in some embodiments, the plant 102 includes any number of processing units that each perform different tasks for producing a final product (e.g., a blended, constructed, or otherwise combined product) from one or more input ingredients.

The plant 102 may, for example, be processing plant that receives and processes ingredients as inputs to create a final product, such as a hydrocarbon processing plant. The plant 102 may generate waste gasses. In various embodiments, waste gasses may be released to atmosphere, such as through a stack 104. Alternatively, waste gases may be flared when being released to atmosphere. Additionally, or alternatively, flaring and venting of gases may occur at locations other than a stack 104. For example, smaller quantities of gases at other locations may be released or may leak into the atmosphere. In some embodiments, locations other than a stack 104 where gases may be vented and/or flared may include well heads, safety release valves, pipe headers, and/or the like.

The plant 102 in some embodiments includes any number of individual processing units. The processing units may each embody an asset of the plant 102 that performs a particular function during operation of the plant 102. For example in the example context of a particular oil refinery embodying the plant 102, the processing units may include a crude processing unit, a hydrotreating unit, an isomerization unit, a vapor recovery unit, a catalytic cracking unit, a aromatics reduction unit, a visbreaker unit, a storage tank, a blender, and/or the like that perform a particular operation for transforming, storing, and/or otherwise handling one or more input ingredient(s). In some embodiments, each individual unit embodying a component of the plant 102 is associated with a determinable location. The determinable location of a particular unit in some embodiments represents an absolute position (e.g., GPS coordinates, latitude and longitude locations, and/or the like) or a relative position (e.g., a point representation of the location of a unit from a local origin point corresponding to the plant 102). In some embodiments, a unit includes or otherwise is associated with a location sensor and/or software-driven location services that provide the location data representing the location corresponding to that unit. In other embodiments the location of a unit is stored and/or otherwise predetermined within a software environment, provided by a user and/or otherwise determinable to one or more systems, for example including the operations processing system 140.

Additionally or alternatively, in some embodiments, the plant 102 itself is associated with a determinable location. The determinable location of the plant 102 in some embodiments represents an absolute position (e.g., GPS coordinates, latitude and longitude locations, an address, and/or the like) or a relative position of the plant (e.g., an identifier representing the location of the plant 102 as compared to one or more other plants, an enterprise headquarters, or general description in the world for example based at least in part on continent, state, or other definable region). In some embodiments, the plant 102 includes or otherwise is associated with a location sensor and/or software-driven location services that provide the location data corresponding to the plant 102. In other embodiments, the location of the plant 102 is stored and/or otherwise determinable to one or more systems, for example including the operations processing system 140.

The flame 110 may be associated with flaring. Flaring involves the igniting and burning of concentrations of flammable gases. A gas may be comprised of a plurality of concentrations of individual gases, and some of these concentrations of individual gases may be flammable. Alternatively, a gas may be comprised of a concentration of an individual gas, which may or may not be flammable. In some embodiments, a gas may contain greenhouse gases, such as hydrocarbons. The hydrocarbons may be ignited by an ignition source, such as a pilot flame, when the gas passes by the ignition source. The ignited gas(es) may be referred to as flares, and this process may be referred to as flaring. In various embodiments, flaring may occur at the flaring stack 104, which may be at a high level of elevation from one or more other components of a plant 102, process area, piping, and the like associated with a site.

In embodiments with gases comprising hydrocarbons, the flaring of hydrocarbons will include lower emissions than the venting of the same gas(es). This is because flaring converts the hydrocarbons in the gas(es) to CO2 and water while venting does not change the composition of the waste gas to water. Thus the flaring may reduce the emissions of hydrocarbons into the atmosphere. In contrast to flaring, venting does not use combustion and, instead, is a direct release of gas(es) to the atmosphere. While FIG. 1 illustrates a flame 110, it will also be appreciated that by removing or omitting an ignition source, such as a pilot flame, gas(es) may be vented without flaring.

The one or more sensors 120 may include sensors to detect, measure, and/or analyze data associated with operation of one or more plant(s), for example the plant 102. In one such example context, the sensors detect, measure, and/or analyze a flame 110 and/or a gas emission, for example associated with a flaring and/or a venting. In some embodiments, a sensor 120 may include a camera, which may be configured to capture images and/or video in one or more spectrums of light. For example, a camera may be configured to capture images and/or video in the visible spectrum. Additional, and/or alternatively, a camera may be configured to capture images and/or video in the infrared spectrum. It will be appreciated that any number of sensor(s), sensor type(s), and/or the like may be utilized to monitor operations of a particular plant, and/or multiple plant(s).

In some embodiments, a sensor 120 (e.g., a camera) may be configured to perform or execute one or more operations and/or functions with determining a type, quantity, and/or volume of gas flared and/or emitted. For example, a camera may capture both visible light and infrared light to generate images and/or video of flaring. Based on these images and/or video of flaring, the camera may determine a type of gas being in a flame 110 as well as a volume of gas flared. In another example with a gas emission that is vented and not flared, a camera may capture both visible light and infrared light to generate images and/or video of venting. Based on these images and/or video of venting, the camera may determine a type of gas being in a flame 110 as well as a volume of gas flared. In various embodiments, a sensor 120 may generate sensor data (e.g., a camera generating images and/or video) and transmit the sensor data over a network 130.

The network 130 may be embodied in any of a myriad of network configurations. In some embodiments, the network 130 may be a public network (e.g., the Internet). In some embodiments, the network 130 may be a private a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The operations processing system 140 may be located remotely or in proximity of a particular plant, for example the plant 102. In this regard, in some embodiments, the operations processing system 140 may be located remotely or in proximity to the emissions sources, such as flame 110. In some embodiments, the operations processing system 140 is configured via hardware, software, firmware, and/or a combination thereof, to perform data intake of one or more types of data associated with one or more plant(s), for example the plant 102. Additionally or alternatively, in some embodiments, the operations processing system 140 is configured via hardware, software, firmware, and/or a combination thercof, to generate and/or transmit command(s) that control, adjust, or otherwise impact operations of a particular plant or specific component(s) thereof, for example for controlling one or more operations of the plant 102. Additionally or alternatively still, in some embodiments, the operations processing system 140 is configured via hardware, software, firmware, and/or a combination thereof, to perform data reporting and/or other data output process(es) associated with monitoring or otherwise analyzing operations of one or more processing plant(s), for example for generating and/or outputting report(s) corresponding to the operations performed via the plant 102. For example, in various embodiments, the operations processing system 140 may be configured to execute and/or perform one or more operations and/or functions described herein.

The one or more databases 150 may be configured to receive, store, and/or transmit data. In various embodiments, the one or more databases may be associated with sensor data received from sensors 120. The sensor data may include historical sensor data as well as current and/or real-time sensor data. Additionally or alternatively, in some embodiments the one or more databases 150 store user inputted data associated with operations of one or more plant(s). In some embodiments, the one or more databases 150 store data associated with multiple individual plant(s), for example multiple plants associated with the same enterprise entity but located in different geographic locations across the world.

The one or more user devices 160 may be associated with users of the operations processing system 140. In various embodiments, the operations processing system 140 may generate and/or transmit a message, alert, or indication to a user via a user device 160. Additionally, or alternatively, a user device 160 may be utilized by a user to remotely access an operations processing system 140. This may be by, for example, an application operating on the user device 160. A user may access the operations processing system 140 remotely, including one or more visualizations, reports, and/or real-time displays.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the operations processing system 140 may include one or more databases 150, which may collectively be located in or at the plant 102.

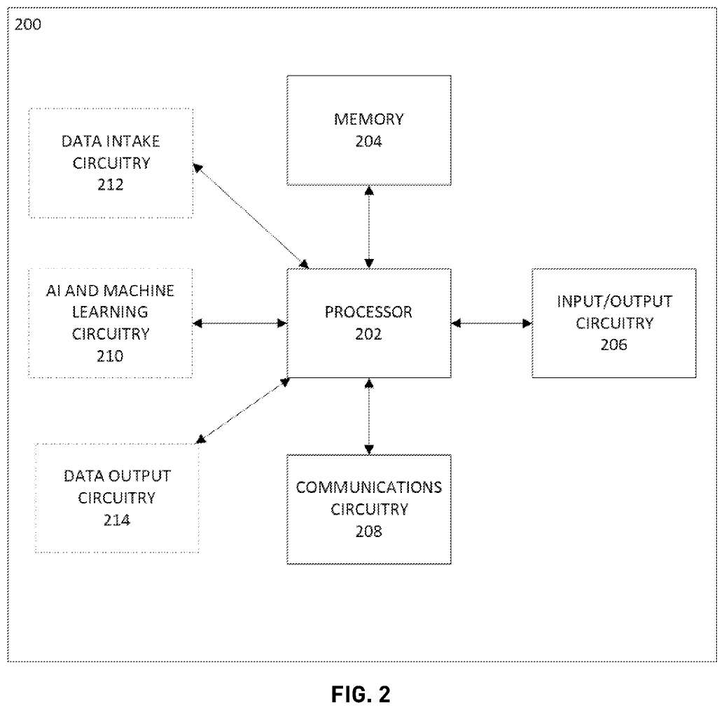

FIG. 2 illustrates an exemplary block diagram of an example apparatus that may be specially configured in accordance with an example embodiment of the present disclosure. Specifically, FIG. 2 depicts an example computing apparatus embodying a data reporting apparatus 200 (“apparatus 200”) specially configured in accordance with at least some example embodiments of the present disclosure. Examples of an apparatus 200 may include, but is not limited to, a sensor 120, the operations processing system 140, a database 150, and/or a user device 160. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory/memories, circuitry/circuitries, and/or the like to perform their associated functions such that duplicate hardware is not required for each set of circuitry.

In various embodiments, such as an computing apparatus 200 of an operations processing system 140 or of a user device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of one or more plant(s). In some embodiments, the data intake circuitry 212 includes hardware, software, firmware, and/or a combination thereof, that communicates with one or more sensor(s), unit(s), and/or the like within a particular plant to receive particular data associated with such operations of the plant. The data intake circuitry 212 may support such operations for any number of individual plants. Additionally or alternatively, in some embodiments, the data intake circuitry 212 includes hardware, software, firmware, and/or a combination thereof, that retrieves particular data associated with one or more plant(s) from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

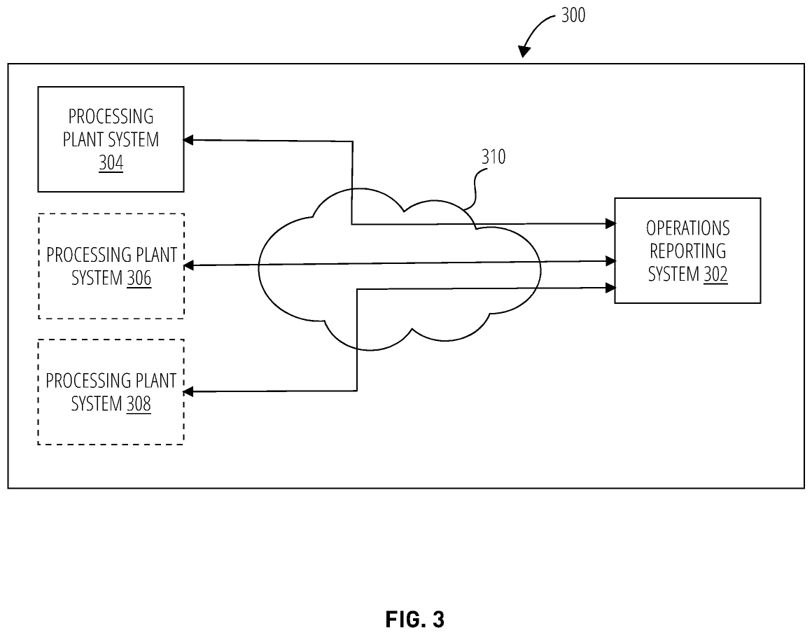

FIG. 3 illustrates an example communication system within which embodiments of the present disclosure may operate. Specifically, FIG. 3 depicts an example system 300. As illustrated, the system 300 includes a processing plant system 304 in communication with an operations reporting system 302. Additionally, in some embodiments, the system 300 includes any number of additional processing plant system(s), for example the optional processing plant system 306 and/or optional processing plant system 308. In some embodiments, the operations reporting system 302 is embodied by or as a sub-system of a processing plant or plurality of processing plants, for example as part of one or more of the processing plant system 304, processing plant system 306, and/or processing plant system 308. In some embodiments, the operations reporting system 302 communicates with one or more of the processing plant system 304, processing plant system 306, and/or processing plant system 308 via one or more communication network(s), for example a communications network 310. In some embodiments, the operations reporting system 302 communicates with each processing plant system over a different communications network or portion thereof.

It will be appreciated that the communications network 310 in some embodiments is embodied in any of a myriad of network configurations. In some embodiments, the communications network 310 embodies a public network (e.g., the Internet). In some embodiments, the communications network 310 embodies a private network (e.g., an internal localized, or closed-off network between particular devices). In some other embodiments, the communications network 310 embodies a hybrid network (e.g., a network enabling internal communications between particular connected devices and external communications with other devices). The communications network 310 in some embodiments includes one or more base station(s), relay(s), router(s), switch(es), cell tower(s), communications cable(s) and/or associated routing station(s), and/or the like. In some embodiments, the communications network 310 includes one or more user controlled computing device(s) (e.g., a user owned router and/or modem) and/or one or more external utility devices (e.g., Internet service provider communication tower(s) and/or other device(s)).

Each of the components of the system 300 communicatively coupled to transmit data to and/or receive data from one another over the same or different wireless and/or wired networks embodying the communications network 310. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 3 illustrate certain system entities as separate, standalone entities communicating over the communications network 310, the various embodiments are not limited to this architecture. In other embodiments, one or more computing entities share one or more components, hardware, and/or the like, or otherwise are embodied by a single computing device such that connection(s) between the computing entities are over the communications network 310 are altered and/or rendered unnecessary. For example, in some embodiments, a processing plant system, such as the processing plant system 304, processing plant system 306, and/or processing plant system 308, includes some or all of the operations reporting system 302, such that an external communications network 310 is not required. Alternatively or additionally, in some embodiments, the operations reporting system 302 embodies a remote or cloud system accessible to one or more of the processing plant systems, for example processing plant systems 304, 306, and/or 308.

In some embodiments, a processing plant system, such as one or more of the processing plant system 304, processing plant system 306, and/or processing plant system 308, and the operations reporting system 302 are embodied at least in part by an on-premises system within or associated with a processing plant. In some such embodiments, the processing plant system(s) and the operations reporting system 302 are communicatively coupled via at least one wired connection. Alternatively or additionally, in some embodiments, a processing plant system, for example one or more of the processing plant system 304, processing plant system 306, and/or processing plant system 308, embodies or includes the operations reporting system 302, for example as a software component of one or more enterprise terminal(s) thereof.

The processing plant systems, such as any one of the processing plant system 304, processing plant system 306, and/or processing plant system 308, includes any number of computing device(s), system(s), physical component(s), and/or the like, that facilitates producing of any number of final products utilizing particular configurations and/or operations that cause processing of input ingredient(s) available to the processing plant associated with the processing plant system. Non-limiting examples of the processing plant system 304, processing plant system 306, and/or processing plant system 308 include some or all of the various components of the environment 100, for example, the plant 102, the stack 104, the sensors 120, the one or more databases 150, and/or the like.

In some embodiments, the processing plant system, for example one or each of the processing plant system 304, processing plant system 306, and/or processing plant system 308, includes or otherwise controls a processing plant including one or more physical component(s), connection(s) between physical component(s), and/or computing system(s) that control operation of each physical component thereof. In one example context, the processing plant system embodies an oil refinery, which includes physical component(s) embodying rundown blender(s), batch blender(s), product tank(s), or other component(s) that perform particular process(es) to alter properties of inputs to the component, crude flow unit(s), piping between such physical component(s), valve(s) controlling flow between the physical component(s), and/or the like. In another example context, the processing plant system embodies a petrochemical or other chemical processing plant, which includes physical component(s) embodying processing units that intake and/or modify particular input ingredient(s). Additionally or alternatively, in some embodiments the processing plant system includes one or more computing system(s) that are specially configured to operate the physical component(s) in a manner that produces one or more particular product(s) simultaneously. In some embodiments, a processing plant system includes one or more computing device(s) and/or system(s) embodied in hardware, software, firmware, and/or a combination thereof, that configure and/or otherwise control operation of one or more physical component(s) in the processing plant. For example, in some embodiments, such computing device(s) and/or system(s) include one or more programmable logic controller(s), model-predictive control system(s), application server(s), centralized control system(s), and/or the like, that control(s) configuration and/or operation of at least one physical component. It will be appreciated that different processing plant system(s) may include or otherwise be associated with different physical component(s), computing system(s), and/or the like. For example, different refinery plants may include different components, different types of components, different number of components, different types of components, and/or the like, that cause the processing plant system to operate differently from other processing plants.

The operations reporting system 302 includes one or more computing device(s) and/or system(s) embodied in hardware, software, firmware, and/or a combination thereof, that monitors, controls, and/or otherwise interacts with at least one processing plant, for example embodied by or included in the processing plant system 304, processing plant system 306, and/or processing plant system 308. For example, in some embodiments, the operations reporting system 302 embodies or includes the operations processing system 140. Additionally or alternatively, in some embodiments, the operations reporting system 302 includes one or more client device(s), user device(s), and/or the like, that enable access to the functionality provided via the operations reporting system 302, for example via a web application, a native application, and/or the like executed on the client device.

In some embodiments, the operations reporting system 302 receives operations data associated with a particular processing plant. For example, in some embodiments, the operations reporting system 302 receives operations data associated with particular operations of a processing unit of a processing plant, such that the operations reporting system 302 may receive operations data corresponding to each processing unit of any number of processing units in the processing plant. Additionally or alternatively, in some embodiments, the operations reporting system 302 receives operations data representing operation of the processing plant, where such operations data includes the individual operations data for one or more processing unit(s), aggregated operations data associated with the processing units thereof, and/or the like.

In some embodiments, the operations reporting system 302 receives operations data through direct communication with one or more sensor(s) disposed within a processing plant. In some embodiments, the sensor(s) include one or more subcomponent(s) of a processing unit. In other embodiments, the sensor(s) include one or more external sensor(s) that engage, view, or otherwise interact within the environment of at least one processing unit within the processing plant. For example, in some embodiments the operations reporting system 302 receives operations data representing at least a portion of operations of a processing plant directly from such sensor(s) in real-time (e.g., directly upon capture from the sensor) or near real-time (e.g., with one or more intermediary pre-processing steps performed before such operations data reaches the operations reporting system 302). Additionally or alternatively, in some embodiments, operations data is received from one or more non-real-time external systems that collect, aggregate, store, and/or otherwise generate the operations data. Additionally or alternatively, in some embodiments, the operations reporting system 302 receives operations data in response to user input directly to the operations reporting system 302, or indirectly submitted to another system communicable with the operations reporting system 302.

In some embodiments, the operations reporting system 302 receives operations data over time, and stores the operations data in at least one data repository embodied in or otherwise accessible to the operations reporting system 302. In some such embodiments, the operations reporting system 302 may aggregate the operations data, including real-time operations data and/or non-real-time data, across time within a data repository, such that the operations data is received from the data repository at a future timestamp for subsequent processing.

Additionally or alternatively, in some embodiments, the operations reporting system 302 receives location data associated with a processing plant. In some embodiments, the location data represents a location of a particular processing unit in a processing plant, for example embodied by or a part of processing plant system 304, processing plant system 306, and/or processing plant system 308. Additionally or alternatively, in some embodiments, the location data represents a particular location associated with the processing plant itself. In some embodiments, the location data representing operation of the processing plant is identified by a particular location sensor, for example a location sensor corresponding to a processing unit of the processing plant. In some such embodiments, a plurality of processing units in the processing plant each include or are otherwise associated with a location sensor, for example such that the location data associated with the particular processing unit is determinable via the location sensor corresponding to that processing unit. Additionally or alternatively, in some embodiments, a processing plant is associated with a single location sensor, for example such that a location associated with the operations of the processing plant overall is determinable via the single location sensor. Non-limiting examples of a location sensor include a GPS sensor, a latitude and longitude sensor, and/or other hardware, software, firmware, and/or a combination thereof that determines an absolute or relative position of such hardware in the world. Alternatively or additionally, in some embodiments, the location data associated with operations of a particular processing plant is predetermined, static, or received in response to user input corresponding to that particular processing plant.

Additionally or alternatively, in some embodiments, the operations reporting system 302 selects a particular reporting protocol for use associated with a particular processing plant, for example embodied by or as part of the processing plant system 304, processing plant system 306, and/or processing plant system 308. In some embodiments, the operations reporting system 302 selects a reporting protocol from a set of candidate protocols. In some such embodiments, the operations reporting system 302 selects a reporting protocol utilizing a specially configured artificial intelligence model. In some such embodiments, for example, the artificial intelligence model may be specially configured to select a reporting protocol (e.g., from a set of candidate protocols) for a particular processing plant based at least in part on location data associated with the processing plant, or particular processing unit(s) thereof. Additionally or alternatively, in some embodiments, the operations reporting system 302 generates an operational report based at least in part on a selected reporting protocol, and/or particular operations data. Additionally or alternatively, in some embodiments, the operations reporting system 302 causes rendering of a specially configured user interface based at least in part on a generated operational report.

In some embodiments, the operations reporting system 302 selects a different reporting protocol for different processing plants associated based at least in part on different data associated with such different processing plants. For example, in some embodiments, the processing plant system 304 is located at a first location, processing plant system 306 is located in at a second location, and processing plant system 308 is located in a third location. Each of the first location, second location, and third location may be represented by different location data, and each located within different jurisdictions (e.g., different states, countries, and/or the like). In this regard, in some embodiments, the artificial intelligence model learns differences between reporting protocols for use associated with each of such locations, as described herein.

In some embodiments, the operations reporting system 302 controls operation of a particular processing plant, for example via a correspond system such as the processing plant system 304. For example, in some embodiments, the operations reporting system 302 generates and/or transmits commands, configuration data, and/or the like utilized to reconfigure at least one processing unit of the processing plant.

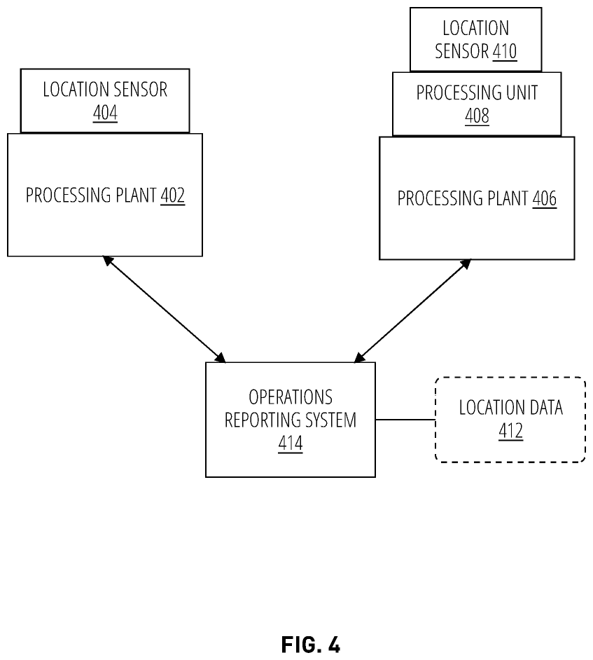

FIG. 4 illustrates example communication of location data in accordance with at least some embodiments of the present disclosure. Specifically, FIG. 4 depicts examples of a particular operations reporting system 414 that receives location data in different manners. For example, in some embodiments, the operations reporting system 414 receives location data representing operation of a particular processing plant in one of the manners described to select a particular reporting protocol associated with a particular processing plant.

In some embodiments, the operations reporting system 414 tracks and/or determines a location associated with operations of any number of processing plants. For example, in some embodiments, the operations reporting system 414 tracks and/or determines a location associated with operations of each processing plant associated with a particular entity, for example each processing plant owner by, operated by, or otherwise associated with a particular enterprise entity. Location data associated with the operations of each processing plant in some embodiments is received by the operations reporting system 414 to indicate the location of a processing plant corresponding to the location data to the operations reporting system 414.

In some embodiments, the operations reporting system 414 receives location data associated with the processing plant 402 from a location sensor 404 associated with the processing plant 402. In some embodiments, the location sensor 404 embodies one or more location sensor(s) positioned within the processing plant 402 or otherwise disposed associated with the processing plant 402. In this regard, the location sensor 404 may generate and/or transmit the location data representing the location of the processing plant 402 to the operations reporting system 414 for further processing. In some embodiments, the operations reporting system 414 receives the location data from the location sensor 404 upon request initiated by the operations reporting system 414. Alternatively or additionally, in some embodiments, the operations reporting system 414 receives the location data from the location sensor 404 at predetermined time(s) and/or upon particular data-driven trigger(s).

Additionally or alternatively, in some embodiments, the operations reporting system 414 receives operational data associated with the processing plant 402 that represents operations of the processing plant. In this regard, the operations data may be received from sensor(s) disposed associated with or otherwise configured to monitor one or more processing unit(s) of the processing plant 402, and/or an environment associated therewith. In some embodiments, some or all of the operations data is received in real-time as operations of the processing plant occur. Additionally or alternatively, in some embodiments, some or all of the operations data is simulated, estimated, or otherwise generated based at least in part on data accessible to the operations reporting system 414 associated with the operations of the processing plant 402. In some embodiments, the operations data represents site level data corresponding to operations of the processing plant 402 in the aggregate.

In some embodiments, the operations reporting system 414 receives location data representing operations of the processing plant 406. In some such embodiments, the processing plant 406 includes any number of processing units, for example the processing unit 408. One or more of such processing units may include or otherwise be associated with a location sensor, for example the location sensor 410 included in or otherwise associated with the processing unit 408. In this regard, the location sensor 410 may generate and/or transmit the location data representing the location of the 408 to the operations reporting system 414 for further processing. In some embodiments, the operations reporting system 414 receives location data from each location sensor associated with each processing unit of the processing plant 406. In this regard, the location of the processing plant 406 may be determined by the location data for a particular processing unit of the processing plant 406, for example the location of the processing unit 408 received from the location sensor 410. Additionally or alternatively still, in some embodiments, the location of the processing plant 406 is determined from a combination of location data associated with a plurality of processing units, for example a determination of a jurisdiction within which all locations represented by the various portions of location data for the processing units are located. In some embodiments, the operations reporting system 414 receives the location data from the location sensor 410 upon request initiated by the operations reporting system 414. Additionally or alternatively, in some embodiments, the operations reporting system 414 receives the location data from the location sensor 410 at predetermined time(s) and/or upon particular data-driven trigger(s).

Additionally or alternatively, in some embodiments, the operations reporting system 414 receives operational data associated with the processing plant 406 that represents operations of the processing plant. In this regard, the operations data may be received from sensor(s) disposed associated with or otherwise configured to monitor one or more processing unit(s) of the processing plant 406, for example the processing unit 408 including one or more sensor(s) that monitor operations as the processing unit 408 functions. In some embodiments, some or all of the operations data is received in real-time as operations of the processing unit 408 occur. Additionally or alternatively, in some embodiments, some or all of the operations data is simulated, estimated, or otherwise generated based at least in part on data accessible to the operations reporting system 414 associated with the operations of the processing plant 406. In some embodiments, the operations data represents unit level data corresponding to operations of the processing unit 408, such that site level data associated with the processing plant 406 is determinable from operations data associated with the processing unit 408 and any other processing units of the processing plant 406.

In some embodiments, the operations reporting system 414 directly receives location data associated with one or more processing plant(s) without accessing a particular location sensor. For example, in some embodiments, the operations reporting system 414 receives location data 412 corresponding to at least one processing plant directly from a system of, in, or associated with the processing plant that stores such data. For example, in some embodiments, the operations reporting system 414 receives the location data 412 from a control system of the processing plant, where the location data is stored in response to user input, predetermined or otherwise statically available to the operations reporting system 414, and/or the like. Additionally or alternatively, in some embodiments, the operations reporting system 414 receives the location data 412 in response to user input to the operations reporting system 414 that indicates the location data for a particular processing plant. Additionally or alternatively still, in some embodiments, the operations reporting system 414 includes or otherwise stores predetermined location data 412 corresponding to a particular processing plant. In some such embodiments, the operations reporting system 414 receives location data corresponding to a particular processing plant by retrieving such location data from at least one data repository, for example by querying the data repository based at least in part on a data identifier that uniquely represents the processing plant, or another key to the data repository.

In some embodiments, the operations reporting system 414 receives and/or maintains enterprise level data associated with a particular one or more processing plants. For example, in some embodiments, the operations reporting system 414 generates or receives enterprise level operations data corresponding to the processing plants 402 and 406. In some such embodiments, the enterprise level operations data may be embodied by an aggregation of operations data, or data derived therefrom, associated with operations of a plurality of processing plants associated with a shared entity (e.g., an enterprise entity that owns, controls, or operates each of such processing plants).

In some embodiments, the location data embodies or includes electronically managed data representing a particular location. For example, in some embodiments, the GPS data, latitude and longitude coordinate data, address data, and a predetermined location identifier (e.g., a custom identifier representing a particular country code, and/or representing another location type. In some embodiments, the location data represents a particular location without subsequent processing. In some other embodiments, the location associated with the processing plant is derived from the location data received by the operations reporting system 414. For example, in some embodiments, the operations reporting system 414 derives the location from the location data by identifying a location within which the location data is positioned (e.g., within a particular jurisdiction, boundary, border, or other defined region representing a particular location).

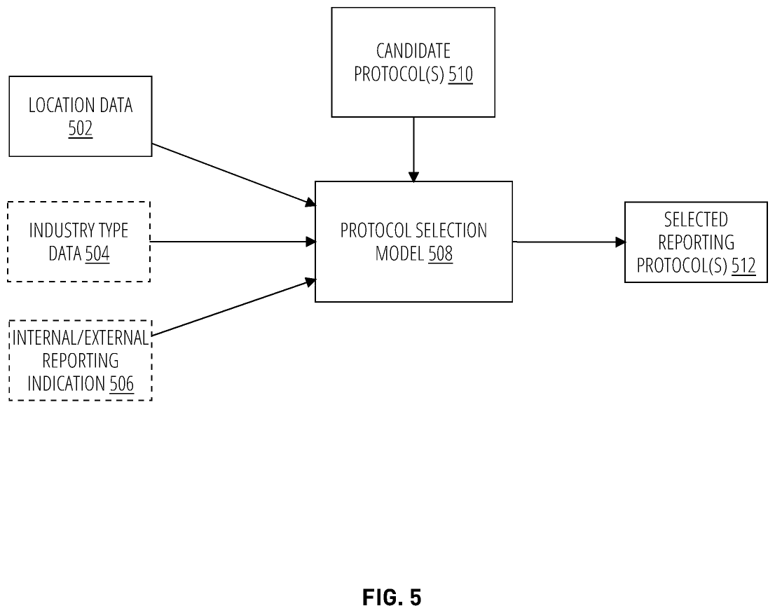

FIG. 5 illustrates an example visualization of computer-implemented operations for selecting a reporting protocol using a protocol selection model in accordance with at least some embodiments of the present disclosure. Specifically, FIG. 5 depicts a visualization of selecting a reporting protocol utilizing a protocol selection model 508. As illustrated, the protocol selection model 508 selects a particular reporting protocol represented by the selected reporting protocol(s) 512. In some embodiments, the data and/or component(s) depicted in FIG. 5 are embodied within a computing environment (e.g., software executed by particular hardware and/or firmware) maintained by the apparatus 200, as depicted and described herein.

In some embodiments, the computing environment includes location data 502 that is inputted into a protocol selection model 508. In some embodiments, the location data 502 is associated with a particular processing plant. For example, in some embodiments, the location data 502 corresponds to a particular processing unit of the processing plant. Additionally or alternatively, in some embodiments, the location data 502 corresponds to the entirety of the processing plant itself. In some embodiments, the location data 502 is received at least in part from a location sensor, for example a location sensor associated with or as part of a processing unit, or included within or otherwise associated with a particular processing plant. In some embodiments, the location data 502 is retrieved from at least one data repository, for example based at least in part on a processing plant identifier that uniquely identifies the processing plant to be processed, and/or a processing unit identifier that uniquely identifies the processing unit to be processed. In some embodiments, the location data 502 is received in response to user input embodying or including at least one value for such location data.

In some embodiments, the computing environment includes optional industry type data 504 that is inputted into a protocol selection model 508. In some embodiments, the industry type data 504 represents a particular industry type associated with a particular processing plant, or particular processing unit thereof, being processed. For example, in some embodiments, the industry type data 504 indicates a type of operations performed by the processing plant, a type of product(s) produced via the processing plant, and/or the like. In some embodiments, the industry type data 504 is received in response to user input embodying or including at least one value for such industry type data. Additionally or alternatively, in some embodiments, the industry type data 504 is determinable or otherwise predetermined associated with a particular processing plant and/or processing unit. Additionally or alternatively, in some embodiments, the industry type data 504 is automatically determined, for example based at least in part on data representing particular type(s), configuration(s), and/or other characteristic(s) of processing unit(s) in a processing plant, operations data associated with a processing plant, and/or the like.

In some embodiments, the computing environment includes optional internal/external reporting indication 506 that is inputted into a protocol selection model 508. In some embodiments, the internal/external reporting indication 506 includes data representing whether the reporting protocol selected is to be utilized to generate an internal reporting or an external reporting. For example, the internal/external reporting indication 506 in some embodiments includes a first data value in a circumstance where the internal/external reporting indication 506 indicates that the reporting protocol is intended to be utilized to generate an operational report embodying an internal reporting, and the internal/external reporting indication 506 includes a second data value in a circumstance where the internal/external reporting indication 506 indicates that the reporting protocol is intended to be utilized to generate an operational report embodying an external reporting. In some embodiments, the internal/external reporting indication 506 is received in response to user input embodying or including at least one data value for such an indication. Additionally or alternatively, in some embodiments, the internal/external reporting indication 506 is automatically determined, for example based at least in part on a target entity selected or otherwise identified to receive a generated operational report.

In some embodiments, the protocol selection model 508 includes a lookup table. In some embodiments, the lookup table includes any number of data structure(s) and/or data record(s) that link particular location data, or a location represented thereby, with a set of candidate protocols. The set of candidate protocols includes any number of reporting protocols that are selectable for use associated with the location represented by the corresponding location data. In some embodiments, the lookup table is embodied by a dictionary, or similar data structure, that utilizes a location or location data as a key corresponding to a value embodying the set of candidate protocols. In some embodiments, the lookup table is generated or inputted by one or more user(s), for example a subject matter expert associated with each location represented in the lookup table. Additionally or alternatively, in some embodiments, the lookup table is generated automatically, for example based at least in part on historically selected reporting protocol(s) associated with a given location. For example, in some embodiments the set of candidate protocols includes each reporting protocol previously selected at least one time associated with a particular location (e.g., a jurisdiction including a plurality of location data points within a defined boundary). In this regard, in some embodiments the protocol selection model 508 identifies the candidate protocol(s) 510 via the lookup table, or the like, and/or utilizes the candidate protocol(s) 510 from which a reporting protocol may be selected, for example embodied by the selected reporting protocol(s) 512. In one example context, the lookup table include a link between a location corresponding to one or more portions of location data and a set of candidate protocols that are indicated as acceptable within a jurisdiction corresponding to the location based at least in part on requirements by a regulator for such a location.

In some embodiments, the protocol selection model 508 includes an artificial intelligence model. The artificial intelligence model of the protocol selection model 508 in some embodiments is configured to generate data corresponding to a candidate reporting protocol that indicates a likelihood that the particular candidate reporting protocol is appropriate for use in generating an operational report for a particular location represented by particular location data, as described herein. Additionally or alternatively, in some embodiments, the protocol selection model 508 generates such a likelihood based at least in part on other input data, for example the industry type data 504 and/or internal/external reporting indication 506. In some embodiments, the artificial intelligence model is specially configured or trained to learn data-driven trends, predictions, and/or the like from data representing historically selected reporting protocols. In this regard, the historically selected reporting protocols may be associated with particular historical location data, historical industry type data, and/or historical internal/external reporting indication, such that the artificial intelligence model may learn particular data trends corresponding to particular data value(s) for such input data or combination(s) thereof. For example, in some embodiments, different historical location data corresponding to different locations may be associated with different historically selected reporting protocols, indicating that different reporting protocols may be appropriate in such different location. In some embodiments, the artificial intelligence model includes the lookup table.

In some embodiments, the protocol selection model 508 outputs selected reporting protocol(s) 512. The selected reporting protocol(s) 512 in some embodiments includes at least one selected reporting protocol determined likely appropriate for use associated with a particular location represented by particular location data, for example the location data 502, and/or other input data. In some embodiments, the selected reporting protocol(s) 512 is selected from a set of candidate protocols, for example the candidate protocol(s) 510. In some embodiments, the candidate protocol(s) 510 includes a selected reporting protocol from the candidate protocol(s) 510 that represents the candidate protocol determined to be associated with a highest likelihood (e.g., represented by a score generated via the protocol selection model 508) of being appropriate for use (e.g., to generate a corresponding operational report) based at least in part on the input data. Additionally or alternatively, in some embodiments, the protocol selection model 508 generates rankings for one or more reporting protocol(s) in the selected reporting protocol(s) 512. The selected reporting protocol(s) 512 in some such embodiments includes any number of reporting protocol(s) and associated ranking(s) for such reporting protocol(s). For example, in some such embodiments, the selected reporting protocol(s) 512 includes an ordered list of multiple selected reporting protocol(s), for example arranged based at least in part on the rankings corresponding to such reporting protocol(s) (e.g., with a top-ranked reporting protocol arranged in a first position, a second-ranked reporting protocol in a second position, and so on). In some embodiments, the rankings correspond to a score representing the likelihood that the corresponding candidate reporting protocol is appropriate for use, as determined by the protocol selection model 508, where a higher score between two corresponds to a higher ranking. In this regard, in some embodiments the protocol selection model 508 selects multiple reporting protocol(s), for example all reporting protocols that are associated with rankings indicating a likelihood above a particular threshold, a top-X (where X represents a numerical value) number of reporting protocols as ranked, and/or the like, for outputting. In some embodiments where the protocol selection model 508 selects multiple reporting protocols, the protocol selection model 508 selects a particular reporting protocol as a default reporting protocol for use, which may be overwritten by user input via a user interface and/or the like.

The apparatus selected reporting protocol(s) 512 may utilize the selected reporting protocol(s) 512 for any of a myriad of processes. In some embodiments, the selected reporting protocol(s) 512 generates an operational report based at least in part on one or more reporting protocol of the selected reporting protocol(s) 512, for example automatically or in response to user input indicating a request to initiate generation of the operational report. Additionally or alternatively, in some embodiments, the selected reporting protocol(s) 512 stores a data record embodying a new historically selected reporting protocol based at least in part on the selected reporting protocol(s) 512, or a portion thereof (e.g., the highest-ranked reporting protocol). The selected reporting protocol(s) 512 may be utilized in any of the downstream operations that utilize a reporting protocol as depicted and described herein.

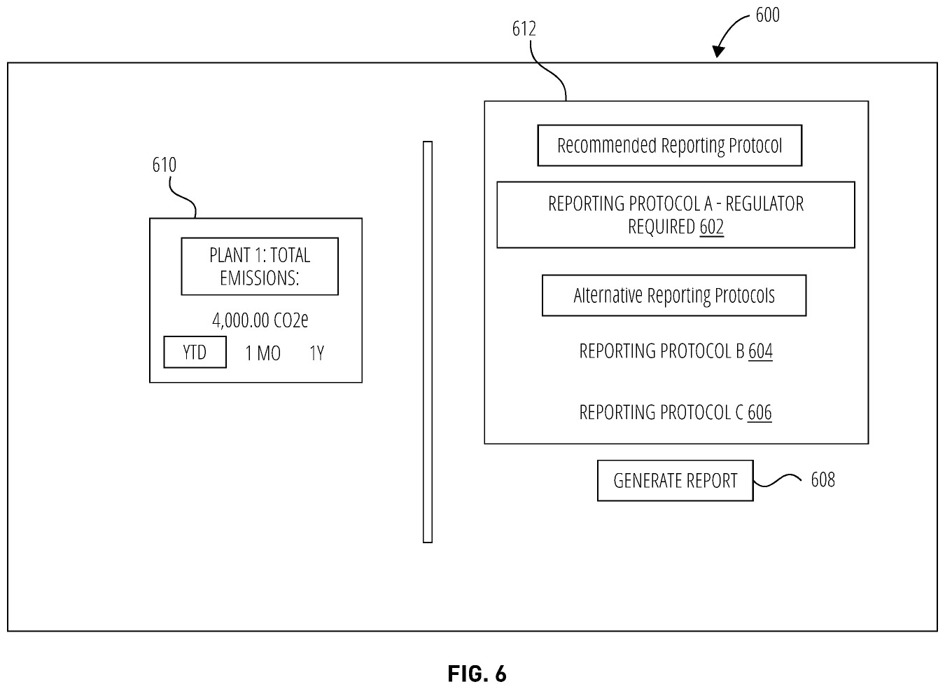

FIG. 6 illustrates an example user interface in accordance with at least some embodiments of the present disclosure. In some embodiments, the user interface is rendered, or caused to be rendered, by a particular system, such as the operations reporting system 302 embodied by the apparatus 200 as depicted and described herein. In some embodiments, the apparatus 200 causes rendering of the user interface to a display of the apparatus 200. Additionally or alternatively, in some embodiments, the apparatus 200 causes rendering of the user interface to a display of another device or system communicable with the apparatus 200. In some embodiments, the apparatus 200 causes rendering of the user interface by transmitting particular data utilized in rendering to the user interface (e.g., a selected reporting protocol, rankings of reporting protocols, and/or the like). For example, in some embodiments the apparatus 200 generates and/or transmits the data embodying the user interface for rendering, and/or transmits the reporting protocol selected for use and/or the rankings of reporting protocols for use in rendering the user interface.

As illustrated, FIG. 6 depicts a user interface 600. In some embodiments, the user interface 600 embodies a user interface rendered to a native application associated with the apparatus 200, for example. In some embodiments, the user interface 600 embodies a web interface accessed by a browser or other web application.

As illustrated, the user interface 600 includes an emissions report sub-interface 610. In some embodiments, the emissions report sub-interface 610 depicts a particular value representing an amount of emissions corresponding to a particular reporting level. For example, in some embodiments, a user may select a particular processing unit to cause rendering of the emissions report sub-interface 610 including emissions data corresponding to that processing unit (e.g., representing a unit level). Alternatively, in some embodiments, a user may select a particular processing plant to cause rendering of the emissions report sub-interface 610 including emissions data corresponding to that processing plant (e.g., based at least in part on all processing units of the processing plant, representing a site level). Alternatively still, in some embodiments, a user may select multiple or all processing plants associated with a particular entity to cause rendering of the emissions report sub-interface 610 including emissions data corresponding to all such processing plants (e.g., representing an enterprise level).

In some embodiments, the emissions report sub-interface 610 represents a particular value derived from one or more portion(s) of operations data. For example, in some embodiments where the user interface 600 corresponds to a particular processing unit, the user interface 600 includes a value in the emissions report sub-interface 610 representing emissions produced or otherwise caused particularly by the processing unit based at least in part on operations data corresponding to that particular processing unit. Additionally or alternatively, in some embodiments where the user interface 600 corresponds to a particular processing plant, the user interface 600 includes a value in the emissions report sub-interface 610 representing emissions produced or otherwise caused particularly by all processing units of the processing plant, or a particular sub-portion of multiple processing units thereof, based at least in part on aggregations of operations data corresponding to each of such processing units. In some embodiments, the operations data utilized to generate the value for the emissions report sub-interface 610 is determined based at least in part on a particular timestamp interval, for example selected by or otherwise inputted by a user associated with the user interface 600. For example, in some embodiments, the user interacts with the emissions report sub-interface 610 to select a timestamp interval of “year-to-date” (YTD), such that operations data within the timestamp interval of the beginning of the year to the current timestamp are utilized to generate the value of the emissions for a particular processing unit, processing plant, or plurality of processing plants. In some embodiments, the user interacts with the emissions report sub-interface 610 to select another timestamp interval utilized to generate the value for the emissions represented in the emissions report sub-interface 610. In some embodiments, the emissions report sub-interface 610 dynamically updates as an alternative timestamp interval is selected.

In some embodiments, the value represented in the emissions report sub-interface 610 is generated based at least in part on a particular reporting protocol selected for use. For example, in some embodiments, the apparatus 200 selects a particular reporting protocol for use with an internal reporting, where the reporting protocol includes particular data utilized to generate an emissions value based at least in part on operations data. In some such embodiments, the reporting protocol may include emissions factor(s) for one or more fuel(s), and/or the like, that is utilized to generate the value represented in the emissions report sub-interface 610.

The user interface 600 further comprises a user interface alert 612. In some embodiments, the user interface alert 612 includes one or more interface element(s) associated with a selected reporting protocol, and/or a plurality of rankings corresponding to one or more selected reporting protocols. In some embodiments, the user interface alert 612 is associated with at least one user interface element configured to initiate generating of an operational report. In some such embodiments, the apparatus 200 may initiate generating of an operational report utilizing a particular reporting protocol engaged with via user input with the user interface alert 612, for example where the user input indicates a selection of a particular reporting protocol outputted to the user interface alert 612. In some embodiments, at least one interface element associated with a particular reporting protocol (e.g., a particular reporting protocol selected by a protocol selection model and/or a top ranked reporting protocol selected via the protocol selection model) is selected by default, for example illustrated by the box surrounding reporting protocol selection element 602 as described herein.

As illustrated, the user interface alert 612 includes interface elements associated with selecting from different reporting protocols. Specifically, the user interface alert 612 includes a reporting protocol selection element 602, reporting protocol selection element 604, and reporting protocol selection element 606, with each of such interface elements corresponding to selection of a different reporting protocol. In some embodiments, the reporting protocol selection element 602 corresponds to a particular reporting protocol selected by a model, and/or selected as associated with a highest rank of a plurality of selected reporting protocols. For example, as illustrated, the reporting protocol selection element 602 corresponds to a particular reporting protocol A, which the reporting protocol selection element 602 indicates is required by a particular regulator. In some embodiments, the protocol selection model that selected the reporting protocol is specially configured to determines that the particular reporting protocol is regulator-required, and causes outputting of data to the user interface 600 accordingly.

Additionally, as illustrated, the reporting protocol selection element 604 corresponds to an alternative reporting protocol B and the reporting protocol selection element 606 corresponds to another alternative reporting protocol C. In this regard, each of the reporting protocol B and reporting protocol C in some embodiments corresponds to other reporting protocol s selected by a particular model. For example, in some embodiments, the protocol selection model may select a particular number of reporting protocols that satisfy a minimum likelihood threshold. A user may interact with the reporting protocol selection element 604 to select the reporting protocol B for use in generating an operational report, and/or may interact with the reporting protocol selection element 606 to select the reporting protocol C for use in generating the operational report.

The user interface 600 further includes generate report control 608. In some embodiments, the generate report control 608 is configured to receive user input, such that upon receiving the user input, the apparatus 200 initiates generation of an operational report based at least in part on a particular reporting protocol. In some such embodiments, the apparatus 200 may determine a reporting protocol selected via the user interface alert 612, for example via user input with the reporting protocol selection element 602, reporting protocol selection element 604, or reporting protocol selection element 606, and utilize the reporting protocol corresponding to the selected interface element to generate the operational report.

For example, in some embodiments, the reporting protocol selected via the user interface alert 612 includes particular data utilized to generate data within the operational report, organize or otherwise arrange data within the operational report, and/or the like. In some embodiments, the selected reporting protocol includes a unit of measurement utilized to calculate particular emissions data values or other data represented in the operational report. Additionally or alternatively, in some embodiments, the selected reporting protocol includes particular emissions factors utilized to generate particular data values included in the operational report (e.g., emissions factors embodying multipliers or other modifiers applied to particular portion(s) of operational data corresponding to a processing unit or processing plant). Additionally or alternatively still, in some embodiments, the selected reporting protocol includes particular data defining required data values to be included in the operational report, and/or arrangements of the operational report to include such data values. In this regard, the apparatus 200 may utilize the selected reporting protocol to generate the operational report based at least in part on the data in the selected reporting protocol (e.g., in a manner that satisfies all requirements in the selected reporting protocol, and/or generates data based at least in part on the data in the selected reporting protocol, and/or the like). The generated operational report may be outputted, for example to the user interface 600 or another user interface, stored to a file, transmitted to another device for processing, storing, displaying, and/or the like, provided to a regulator or external entity, printed from the system to a physical format, and/or the like.

Some embodiments of the present disclosure utilize a selected reporting protocol to generate a user interface alert that includes information associated with targets, penalties, or other information derived based at least in part on a selected reporting protocol. For example, some embodiments determine whether an emissions value generated based at least in part on a selected reporting protocol (e.g., using emissions factors therein, for example) satisfies a particular requirement associated with a particular location of a processing unit, processing plant, and/or the like. In some embodiments, the requirement is embodied by a threshold corresponding to or included in the selected reporting protocol or location. In this regard, some such embodiments may perform at least one determination to assist an entity in avoiding negative impacts of generating operational report(s) utilizing particular reporting protocol(s), for example by selecting a reporting protocol that would not result in such a negative impact based on calculations derived utilizing the selected reporting protocol.

Having described example systems, apparatuses, data architectures, user interfaces in accordance with the present disclosure, example processes for implementing at least one automatically selected reporting protocol will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

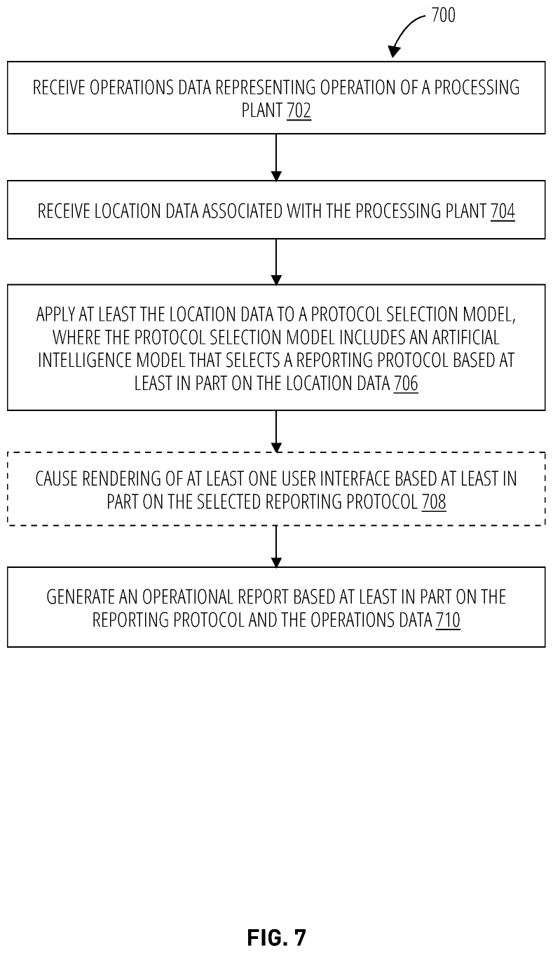

FIG. 7 illustrates a process for implementing at least one automatically selected reporting protocol in accordance with at least some embodiments of the present disclosure. Specifically, FIG. 7 illustrates an example computer-implemented process 700. In some embodiments, the process 700 is embodied by computer program code stored on a non-transitory computer-readable storage medium of a computer program product configured for execution to perform the process as depicted and described. Alternatively or additionally, in some embodiments, the process 700 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like to perform one or more of the operations as depicted and described. For example, the apparatus 200 in some embodiments is in communication with one or more separate processing plant system(s), physical component(s) of a processing plant, and/or the like. For purposes of simplifying the description, the process 700 is described as performed by and from the perspective of the apparatus 200. In some embodiments, the apparatus 200 performs the operations of the process 700 utilizing particular means, such as the AI and machine learning circuitry 210, data intake circuitry 212, data output circuitry 214, processor 202, memory 204, input/output circuitry 206, and/or communications circuitry 208, or a combination thereof.

The process 700 begins at operation 702. According to some examples, the method includes receiving operations data representing operation of a processing plant at operation 702. In some embodiments, the operations data include particular data corresponding to a particular processing unit of the processing plant. In some embodiments, the operations data includes particular data corresponding to multiple processing units of the processing plant. In some embodiments, the apparatus 200 receives some or all of the operations data directly from a processing unit, for example in real-time or at a previous timestamp and stored for subsequent processing. In some embodiments, the apparatus 200 receives some or all of the operations data by retrieving such data from a data repository accessible to the apparatus 200. In some embodiments, the apparatus 200 receives (and/or requests, such that data is received in response to the request) operations data for a particular processing plant utilizing at least one data identifier corresponding to the processing plant.

According to some examples, the method includes receiving location data associated with the processing plant at operation 704. In some embodiments, the location data represents a location of a particular processing unit. In some embodiments, the location data represents a location of the processing plant as a whole. In some embodiments, the apparatus 200 receives the location data from a location sensor associated with a processing unit of the processing plant. In some embodiments, the apparatus 200 receives the location data from a location sensor associated with the processing plant itself (e.g., a location sensor disposed in or otherwise associated with the entirety of the processing plant). In some embodiments, the apparatus 200 receives the location data by retrieving predetermined or previously-stored location data associated with a processing plant, for example from at least one data repository accessible to the apparatus 200. In some embodiments, the apparatus 200 receives (and/or requests, such that data is received in response to the request) location data for a particular processing plant utilizing at least one data identifier corresponding to the processing plant.

According to some examples, the method includes applying at least the location data to a protocol selection model. In some embodiments, the protocol selection model includes an artificial intelligence model that selects a reporting protocol based at least in part on the location data at operation 706. For example, in some embodiments, the artificial intelligence model is configured to select a particular reporting protocol from a set of candidate reporting protocols, where the selected reporting protocol is determined most probable to be usable for a particular location. In this regard, in some embodiments the artificial intelligence model is specially configured to select at least one reporting protocol based at least in part on the location data associated with the processing plant.

In some embodiments, the artificial intelligence model selects from a set of candidate protocols. The set of candidate protocols may include any number of reporting protocols from which the artificial intelligence model may select. For example, in some embodiments, the set of candidate protocols represents a universe of all possible reporting protocols. Additionally or alternatively, in some embodiments, the set of candidate protocols is determined by the artificial intelligence model and/or a sub-model thereof. For example, in some embodiments, the set of candidate protocols is determined by the artificial intelligence model, or a preprocessing step thereof, based at least in part on a lookup table. In some embodiments, the lookup table includes one or more data record(s) that links location data, or a representation of a location associated with such location data, with a corresponding set of candidate protocols associated with such location data. In some embodiments, the set of candidate protocols represents a limited subset of the universe of all candidate protocols that are determined or otherwise indicated as selectable for a particular location represented by the location data. In some embodiments, the lookup table is predetermined, generated by a user (e.g., a subject matter expert for one or more locations corresponding to particular jurisdiction(s)), and/or the like. In some such embodiments, the set of candidate protocols may be applied to the remaining processing of the artificial intelligence model as an input from which a reporting protocol is selected.

Additionally or alternatively, in some embodiments, the artificial intelligence model is specially configured to select at least one reporting protocol based at least in part on one or more additional data input(s). For example, in some embodiments, the apparatus 200 is configured to receive industry type data representing a particular industry type corresponding to the processing plant. In some embodiments, the industry type data is received in response to user input, predetermined or otherwise prestored corresponding to the processing plant, and/or the like. In some such embodiments, the industry type data may be applied to the artificial intelligence model together with at least the location data.

Additionally or alternatively, in some embodiments, the apparatus 200 is configured to receive an indication of an internal reporting or an external reporting, wherein the indication indicates whether the reporting protocol is intended to be utilized to generate an operational report for an internal reporting or an operational report for an external reporting. In some embodiments, the indication of the internal reporting or external reporting is received in response to user input, automatically determined, and/or the like. In some such embodiments, the indication of the internal reporting or external reporting may be applied to the artificial intelligence model together with at least the location data, and/or industry type data, as described herein.

In some embodiments, the artificial intelligence model selects a single reporting protocol. For example, the artificial intelligence model may generate a score indicating a determined likelihood that a particular reporting protocol is appropriate for use, and select the reporting protocol associated with the highest (or otherwise most preferred) score. In other embodiments, the artificial intelligence model ranks one or more reporting protocols. In this regard, in some embodiments the apparatus 200 outputs each reporting protocol as selected in accordance with its rank. In some embodiments, the apparatus 200 selects one or more particular reporting protocol(s) based at least in part on the rank corresponding to each of such particular reporting protocol(s0, for example to only select a certain number of top-ranked reporting protocol(s), and/or the like.

According to some examples, the method optionally includes causing rendering of at least one user interface based at least in part on the selected reporting protocol at operation 708. In some embodiments, the user interface embodies or includes a user interface alert. In some such embodiments, the user interface alert includes at least one selected reporting protocol, for example a selected reporting protocol outputted by the artificial intelligence model, or a plurality of ranked reporting protocols selected by the artificial intelligence model. In some embodiments, the user interface includes interface elements that are configured to receive user input such that, in response to user input associated with a particular interface element, the reporting protocol corresponding to the particular interface element is determined to be selected for subsequent utilization (e.g., in operation 710 described herein). Additionally or alternatively, in some embodiments, the user interface includes at least one interface element representing or including one or more data value(s) generated or arranged based at least in part on a selected reporting protocol (e.g., an emissions value corresponding to the processing plant and/or a particular processing unit thereof having a value generated based at least in part on factor(s) and/or other data retrieved from the selected reporting protocol).

According to some examples, the method includes generating an operational report based at least in part on the reporting protocol and the operations data at operation 710. In some embodiments, the apparatus 200 utilizes one or more portions of data from the selected reporting protocol to determine particular data parameter(s) to be included in the operational report, generate data value(s) for particular data parameter(s) to be included in the operational report, arrange data portions within the operational report, and/or the like. For example, in some embodiments, the apparatus 200 identifies particular emissions factors from the selected reporting protocol, and combines such emissions factors with data value(s) from the operations data to generate particular emissions value(s) associated with operations of the processing plant (e.g., representing the emissions produced by the processing plant as a whole, or particular processing unit(s) thereof). Additionally or alternatively, in some embodiments, the apparatus 200 arranges portion(s) of the operations data, and/or portion(s) of data derived from at least part of the operations data, in a particular manner defined by the selected reporting protocol. In some embodiments, the apparatus 200 outputs the operational report once generated. For example, the apparatus 200 may output the operational report by causing rendering of the operational report to at least one user interface, storing the operational report to a particular data repository, printing the operational report to a physical format, transmitting the operational report to an external entity (e.g., a regulator) for further processing, and/or the like.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for implementing at least one automatically selected reporting protocol comprising:
receiving operations data representing operation of a processing plant;
receiving location data associated with the processing plant;
applying at least the location data to a protocol selection model, wherein the protocol selection model comprises an artificial intelligence model that selects a reporting protocol based at least in part on the location data; and
generating an operational report based at least in part on the reporting protocol and the operations data.

2. The computer-implemented method of claim 1, wherein the operations data corresponds to a reporting level, the reporting level selected from at least one of a unit level, a site level, and an enterprise level.

3. The computer-implemented method of claim 1, wherein the protocol selection model is further configured to select the reporting protocol based at least in part on industry type data.

4. The computer-implemented method of claim 1, the computer-implemented method further comprising:
generating a user interface alert that indicates at least one regulator required reporting protocol and at least the reporting protocol selected by the protocol selection model.

5. The computer-implemented method of claim 1, wherein the protocol selection model receives an indication of internal reporting or external reporting, and wherein the protocol selection model is configured to select the reporting protocol based at least in part on the indication of internal reporting or external reporting.

6. The computer-implemented method of claim 1, wherein the protocol selection model comprises a lookup table that indicates at least one candidate protocol for selection based on the location data, wherein the reporting protocol is selected from the at least one candidate protocol.

7. The computer-implemented method of claim 1, wherein the protocol selection model generates a ranking for each of at least one candidate protocol, the computer-implemented method further comprising:
causing rendering of a user interface comprising the ranking for each of the at least one candidate protocol.

8. The computer-implemented method of claim 1, wherein the artificial intelligence model is configured to predict a probability of each candidate protocol of a plurality of candidate protocols based at least in part on a plurality of historically selected reporting protocol.

9. The computer-implemented method of claim 1, wherein the location data is received from a location sensor of a processing unit of the processing plant.

10. The computer-implemented method of claim 1, wherein the operational report corresponds to a unit level and the location data represents a location of a processing unit of the processing plant.

11. The computer-implemented method of claim 1, wherein the operational report corresponds to a site level and the location data represents the location of the processing plant.

12. The computer-implemented method of claim 1, further comprising:
receiving user input initiating the generation of the operational report, wherein the operational report is generated in response to receiving the user input.

13. The computer-implemented method of claim 1, wherein the generation of the operational report is automatically initiated in response to selection of the reporting protocol.

14. An apparatus comprising:
at least one processor; and
at least one non-transitory memory storing instructions that, when executed by the at least one processor, cause the apparatus to:
receive operations data representing operation of a processing plant;
receive location data associated with the processing plant;
apply at least the location data to a protocol selection model, wherein the protocol selection model comprises an artificial intelligence model that selects a reporting protocol based at least in part on the location data; and
generate an operational report based at least in part on the reporting protocol and the operations data.

15. The apparatus of claim 14, wherein the protocol selection model is further configured to select the reporting protocol based at least in part on industry type data.

16. The apparatus of claim 14, wherein the artificial intelligence model is configured to predict a probability of each candidate protocol of a plurality of candidate protocols based at least in part on a plurality of historically selected reporting protocol.

17. The apparatus of claim 14, wherein the protocol selection model comprises a lookup table that indicates at least one candidate protocol for selection based on the location data, wherein the reporting protocol is selected from the at least one candidate protocol.

18. A computer program product comprising at least one non-transitory computer-readable storage medium, the at least one non-transitory computer-readable storage medium comprising instructions that when executed by at least one processor, configures the computer program product together with the at least one processor to:
receive operations data representing operation of a processing plant;
receive location data associated with the processing plant;
apply at least the location data to a protocol selection model, wherein the protocol selection model comprises an artificial intelligence model that selects a reporting protocol based at least in part on the location data; and
generate an operational report based at least in part on the reporting protocol and the operations data.

19. The computer program product of claim 18, wherein the protocol selection model is further configured to select the reporting protocol based at least in part on industry type data.

20. The computer program product of claim 18, wherein the artificial intelligence model is configured to predict a probability of each candidate protocol of a plurality of candidate protocols based at least in part on a plurality of historically selected reporting protocol.
